(19) United States
(12) Patent Application Publication
(10) Pub. No.: US 2017/0371902 A1
(43) Pub. Date: Dec. 28, 2017

(54) Method, Apparatus and Interface For Creating a Chain of Binary Attribute Relations

(71) Applicant: H. Paul Zellweger, Rochester, MN (US)

(72) Inventor: H. Paul Zellweger, Rochester, MN (US)

(21) Appl. No.: 15/192,798

(22) Filed: Jun. 24, 2016

(51) Int. Cl. G06F 17/30; G06F 3/0482

(52) U.S. Cl. CPC G06F 17/30294; G06F 3/0482; G06F 17/30339

(57) ABSTRACT

Improvements to the techniques used to generate menu data for a content menu (5) are disclosed. They focus on a new model of data networks, the BAR chain (150); a new developers' interface (130); and new program logic that is easier to maintain. The new interface guides developers in their selection of fields and database attributes according to the BAR chain (150). These improvements include context-sensitive options (such as 175 or 184) and enabling developers to navigate from one table to another intuitively (182). These new features widen the audience for this system by lower the technical demands required to use it. When the developer has finished making selections, the development system (27) stores them in an extended form of meta-query data according to the BAR chain (150). This new format (135) generates both runtime and compiled menu data for a content menu (5).

### BACKGROUND

### Field

This application relates to an end-user database interface in general, and to the improvements in automatically generating data for a content menu in particular. This new approach enables a developer to create a model of data relations in a database that represents a data network.

### Prior Art

Zellweger (U.S. Pat. No. 6,131,098) introduced a pioneering way to navigate over database content with the database taxonomy, a knowledge representation of data and data relations. It is an end-user navigation structure that is known as a content menu. This new technology is rooted in the open hierarchical data structure (OHDS), a list of nested data lists, first described by Zellweger (U.S. Pat. No. 5,630,125) in 1997. Initially, the OHDS served as a conduit between the data and its relations in a database and the data displayed in the content menu. The structure of OHDS provided a framework for generating menu data files where each file represents a mutually exclusive network in the OHDS. Over the past decade, Zellweger continued to make improvements to the content menu and its authoring system described throughout multiple disclosures, including U.S. Pat. Nos. 6,243,700 & 6,301,583 that use hypertext and applets for this database interface.

Early on, Zellweger employed menus and specialized software to generate a network of data relations in the OHDS from existing database content. To achieve this outcome, a developer uses the interface disclosed in U.S. Pat. No. 6,131,100 to navigate over a target database. Next, he or she selects database attributes that serve as sources for menu data. Commands in this interface enable the developer to relate raw data in one attribute to records or rows in another table. In a demonstration of the inventor's novelty, this interface also enabled the developer to logically link two attributes within the same table at the data level. Program control formalizes this logical relationship by generating a symbolic expression that models these data relations. Software in U.S. Pat. No. 6,279,005 parses this expression to extract data lists from a target database and add them to the OHDS automatically. In a more recent disclosure made by Zellweger (U.S. Pat. No. 6,131,098), innovative back-end algorithms parse this symbolic expression to extract meta-query data, and store it in its own structure, to generate a list menu for the content menu at runtime.

When parsing the original symbolic expression, specification U.S. Pat. No. 6,131,098 treated the terms in this expression as meta-query data used to construct a query statement at runtime. Burgin's mathematical theory of named sets streamlined the use of meta-query data and led to the discovery of the Binary Attribute Relations (BAR) and the BAR query. With these two new concepts in place, binary attribute data relations were disclosed by Ser. No. 13/033,298 on Feb. 23, 2011.

The ability to encode attribute relationships in a predefined expression was a critical discovery at the time. First and foremost, it challenged Codd's argument against considering such binary attribute relations in the database table (p. 423). This new symbolic expression proved that this pairing of attributes represented meta-query data or data that is used to construct a query statement, something that could not be anticipated by Codd's focus on design issues. Furthermore, this early expression also served as a common denominator between front- and back-end processes in the development system. It enabled any number of front-end processes to communicate with any number of back-end ones. So a menu developer could supply an expression by hand in the front-end, and the back-end could transform this expression into a network of data topics in the OHDS automatically. More recent improvements to this symbolic expression focused on a more compact, efficient form of meta-query data based on the Binary Attribute Relation or BAR format. This new format provided a greater degree of system integration that made the program logic in the development system easier to deploy and to maintain as noted by Ser. No. 13/033,298 filed on Feb. 23, 2011.

The current disclosure improves upon these prior disclosures in three crucial ways. First, by reformulating the terms in the original symbolic expression, a more comprehensive expression emerged—the BAR chain that models data networks. Second, with this new notation came the discovery of the properties and rules that governed the construction of this chain. And third, by identifying these uniform patterns in the BAR chain, new improvements could be applied directly to the developers' interface to make it context-sensitive, the subject of this disclosure.

The BAR chain disclosed in the present specification builds on the discovery of the BAR (Ser. No. 13/033,298 Feb. 23, 2011). It does this by referring to each BAR model as a link in a chain. This new expression now models not only data relations but data relations that model a data network. Burgin's mathematical theory of named sets influenced this new development. However, in the inventor's application of this advanced mathematics, Zellweger is more pragmatic than the original idea. For instance, Zellweger separates out the explicit rules that bind each pair of attributes in the formal notation of a named set. This separation now allows a single recursive algorithm to process each pair of attributes in the chain. In turn, the BAR chain was less cluttered, thereby enabling Zellweger to inspect and analyze each link in the chain's progression. The inventor's BAR chain notation, which will be presented shortly in FIG. 10b simplifies Burgin's theoretical mathematics to suit the computational setting of a computer.

By viewing each BAR representation as interrelated links in a chain, the actual mechanical rules on pairing two attributes together in the progression of these models could now be investigated in a systematic fashion. This discovery led the inventor to reformulate the original attribute expression presented by U.S. Pat. No. 6,279,005. FIG. 10b shows the new one. This new symbolic expression allowed Zellweger to consider its impact of on the developers' interface and on interface's ability to guide and assist the developer.

The most significant improvement brought about by the BAR chain was that the new developers' interface, to could guide developers in their navigation over a target database schema. The new interface now only displays options that are both relevant and valid, something which was missing in the old interface, which, as one would expect, could only be used by experts. In effect, this new interface lowers the degree of technical training and know-how required to use it, thereby broadening its intended overall audience to include nontechnical professionals as well.

Recent disclosures made by other inventors employ “meta-data” to describe their disclosures; however, they apply this term in a very different manner than that of the inventor. In Zellweger's use of this term, each unit of meta-query data is formally defined in Ser. No. 13/033,298 as data that contributes to the construction of a query statement. In contrast, U.S. Pat. No. 5,664,173 by Fast discloses how to employ meta-data for a hierarchically ordered information server. This metadata has nothing to do with the construction of a query statement. Fast's meta-data refers to content information, application information, and configuration information. In another disclosure about meta-data, Thomas et. al in U.S. Pat. No. 6,061,692, describes how to generate meta-data for test systems that verify the syntax of a query. Once again, this description of meta-data has nothing to do with extracting raw data from a database to create an end-user interface like the applicant's content menu. More to the point, neither one of these disclosures employs meta-data to represent data relations in the database because until now no such models existed.

### DRAWINGS—BRIEF DESCRIPTION OF THE FIGURES

FIG. 1 depicts the content menu, an end-user database interface that organizes database content into a knowledge representation known as a “database taxonomy.”

FIG. 2 shows the client-server network apparatus of the content menu.

FIGS. 3a-3b depict the primary software components of the content menu, including a development system that generates menu data files, the menu data files themselves, and the browser software that displays the details of these files in a content menu.

FIGS. 4a through 4c depict the Book Inventory database system used to demonstrate the new interface and its program logic disclosed in this specification.

FIG. 5 shows the open hierarchical data structure (OHDS) that organizes data and data relations in a target database system for the content menu.

FIG. 6 depicts the database table that stores the OHDS structure.

FIGS. 7a through 7c illustrate the former developers' interface used to generate the old symbolic expression.

FIGS. 8a and 8b depict an overview of the program flow in capturing meta-query data in the new and old disclosures.

FIGS. 9a and 9b show the old and new file formats used to store meta-query data.

FIGS. 10a and 10b display the Binary Attribute Relation or BAR and its relationship to the BAR chain, the new concept and technique presented by the current disclosure.

FIGS. 11a through 11e depict the new developer's interface that guides the developer in capturing meta-query data.

FIGS. 12a and 12b show the relationship between the new developers' interface and the meta-query data that it captures from the perspective of the BAR chain.

FIG. 13 depicts the architecture and new software components of the client-server architecture.

FIGS. 14a through 14d illustrate the new program flow of the new developers' interface along with the new software components that generate menu data.

### DRAWINGS—DETAILED DESCRIPTION

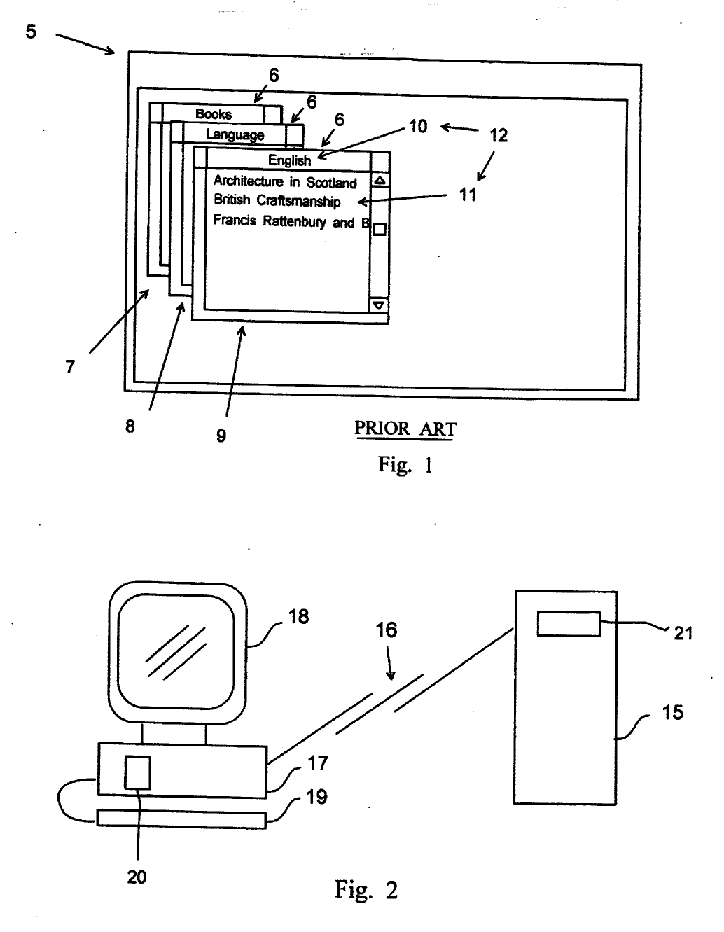

FIG. 1 shows the database interface that is known as content menu 5. Graphical user interface (GUI) 5 consists of one or more nested lists 6 that display the data and its relations in the DBMS as nested lists. The structure of the data content in GUI 5 depicts a knowledge representation called the database taxonomy. Each list menu 6 in content menu 5, like 7 or 8, consists of two parts: 1) one or more data topics in a scrolling display like region 11, and 2) a list menu header 10 that was selected by the end-user in the most recent list menu 6 of content menu 5.

The relationship between header topic 10 and list 11 is significant because it represents data relation 12, a one-to-one or one-to-many mapping that exists in all database applications. Data relation 12 was introduced and presented in detail by U.S. patent. Ser. No. 13/033,298 as Binary Attribute Data Relations or BADR. This relationship occurs naturally in the relational database as well as in other data models, storage structures, RDF files, data structures, and even in computer files that have field and record structures (including both fixed and variable length field). However, only the BAR query, a retrieval command in the disclosure mentioned above, can construct data relation 12. In FIG. 1, data relation 12 represents a logical relationship between two sets of data. The fact that it can arbitrarily represent “one-to-one” or “one-to-many” relationships makes it difficult to see and to identify until now. Before the inventor's disclosure of binary attribute data relations, data relation 12 was hidden from view.

Each time the end-user selects an item in list 11, content menu 5 generates a new data topic list menu 6 that refines the most recently selected topic. At the end of each menu path, content menu 5 presents a window that displays information that corresponds to the items selected by end-users. A primary key embedded in the final step of a chain of data relation links to this window. Alternative embodiments of the content menu 5 include end-user navigation structures or graphical interfaces that represent such menu paths or nested topic lists in a tree-view interface, in an applet (U.S. Pat. No. 6,301,583) and even in nested hypertext lists (U.S. Pat. No. 6,243,700). Embellishments to the preferred and alternative embodiments of these navigation structures include graphic icons and sound clips as topic entries.

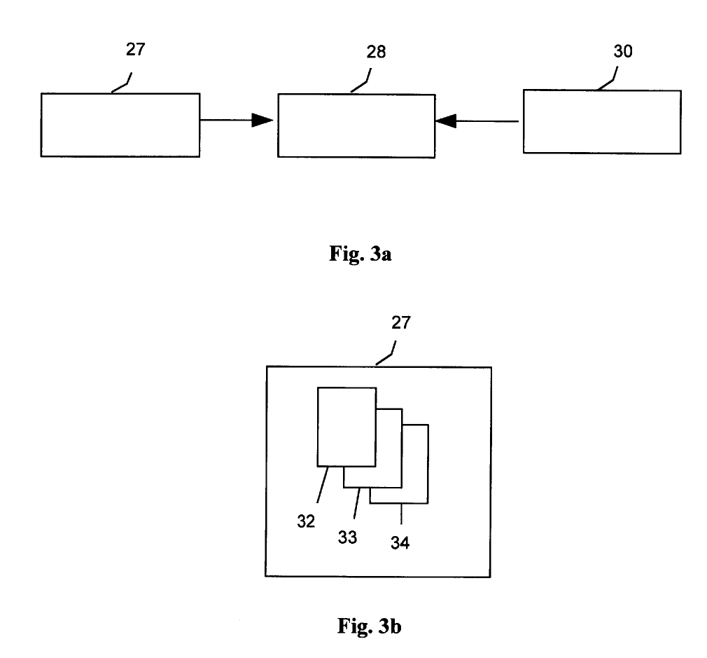

The diagram in FIG. 2 shows the client-server network apparatus of the present invention. A client computer 17 links electronically to server computer 15. Linkage 16 includes any combination of physical cabling and wireless connections. The client computer 17 has CPU 20 and server computer 15 has CPU 21. Server 15 is responsible for preparing menu data for the content menu 5 displayed on monitor 18 of client 17. An end-user on client 17 employs an input device like keyboard 19 on 17 to make selections in content menu 5 and or to input text to use and navigate content menu 5.

Alternative input devices on client 17 include touch screens, pointing devices like a mouse, voice-activated systems, and other types of sensory input devices that would enable an end-user to make selections in content menu 5. The monitor 18 on client 17 displays content menu 5 visually as a graphic image; alternative output devices include “talking software” systems that would enable an end-user to receive auditory descriptions of the menu. Alternative embodiments of the network configuration include a stand-alone computer where the menu data associated with content menu 5 resides on a local data storage device. Alternative embodiments to this independent setting include any computing device on a wireless network, regardless of its size or sensory interaction, that enables communication with an end-user by presenting information requested by that end-user.

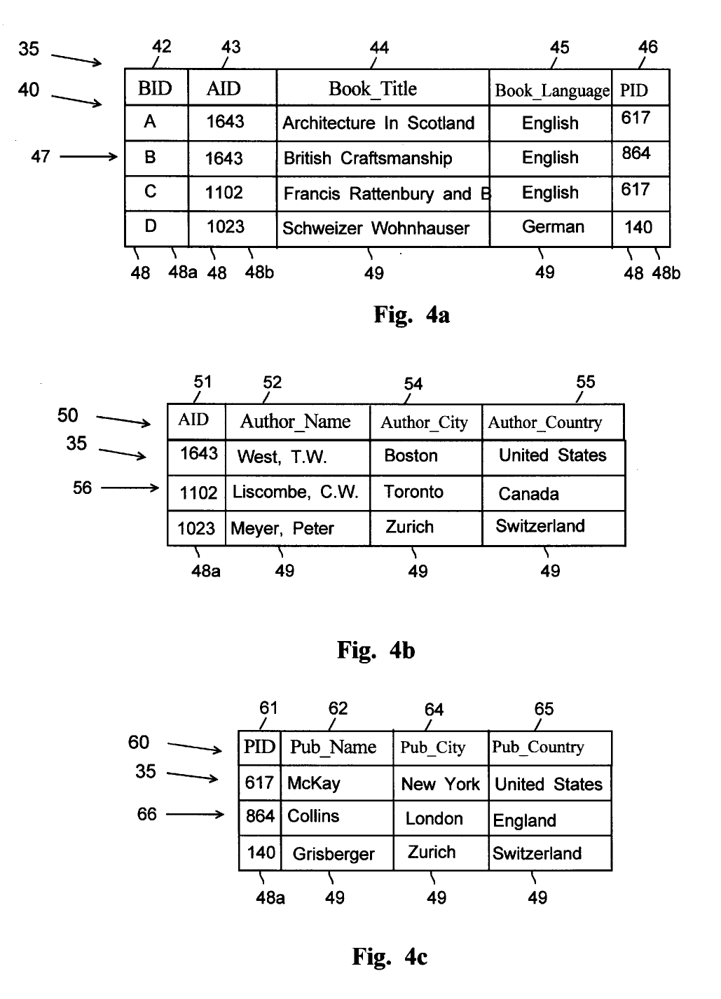

FIGS. 3a-3b illustrate the three primary software components of the content menu 5. FIG. 3a shows an overview of these parts. It includes the development system 27 that generates the second part of this system, menu data files 28. Browser software 30, the third part, displays the details of menu data files 28 on content menu 5 on a client computer 17. Depending upon the configuration of content menu 5, its display can either be a thin client or server-based.

FIG. 3b presents a thumbnail of the core program logic in authoring system 27 responsible for generating menu data. These algorithms include a data dictionary 32 that controls access to a target database at the table and attribute levels, modeling tools 33 such as the new interface 130 and program logic 132 that represent data networks in the external database, and production tools 34 to generate menu data files 28.

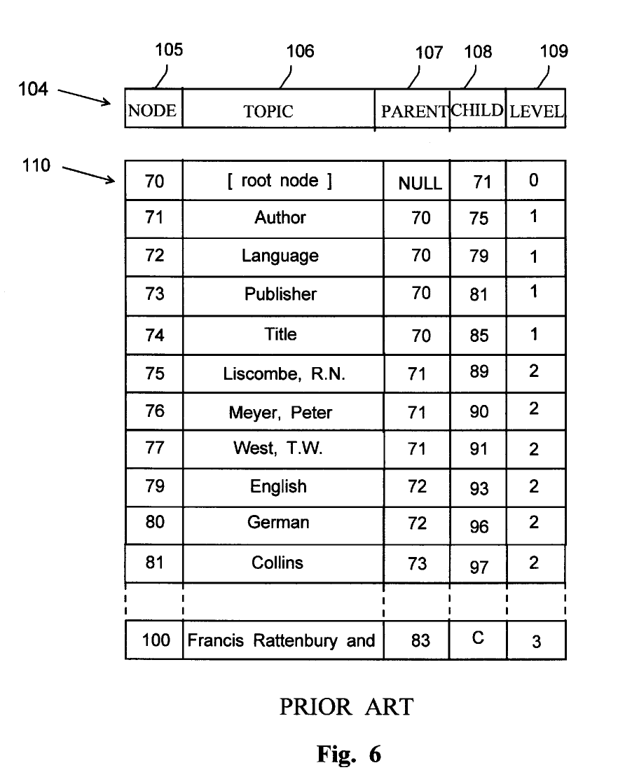

In the prior disclosure, development system 27 builds and maintains an open hierarchical data structure (OHDS) to organize menu data into a single, unified data structure. FIG. 5 presents the details of OHDS 68. Development system 27 employs OHDS 68 as a framework for the production tools 34 that generate compiled menu data files 28. Each menu data file 28 represents a mutually exclusive network segment of OHDS 68. In one application setting, browser software 30 on client 17 requests a particular menu data file 28 over the network to display one or more list menu 6 in content menu 5. In another setting, algorithms on server 15 parse menu data file 28 to prepare server-based presentations of menu data for the client. According to the new techniques presented here, software tools 34 in development system 27 enable a menu data file 28 to be built either on demand at runtime or file 28 can be compiled ahead of time in the production run.

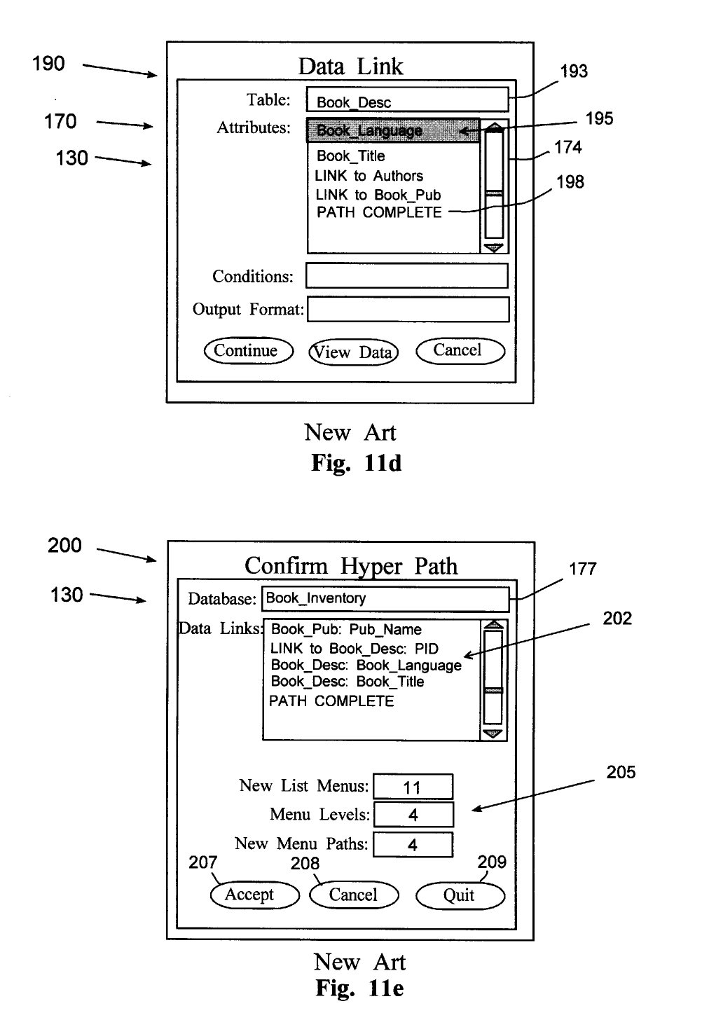

In this new approach, development system 27 has modeling tools 33 that include the new developers' interface 130 shown in FIGS. 11a through 11e. The developer uses interface 130 to create a model of a data network based on the properties and rules of the BAR chain, the subject of this new technique. As outlined in the scenario of these drawings, interface 130 guides the developer in navigating over an external database, by only presenting options that are consistent with the rules that govern the formation of the BAR chain.

In the preferred embodiment of the present invention, development system 27 resides on server 15, and it maintains menu data files 28 on there as well. In alternative embodiments of this new technology—say in a standalone system, the authoring system 27, the browser software 30 and data files 28 all reside on the same computer. In this setting, development system 27 also manages all of the meta-query data on the same computer or on any other computer that can be reached by a network connection. In other words, development system 27, menu data files 28, meta-query data, and the target database files can reside anywhere in a connected network.

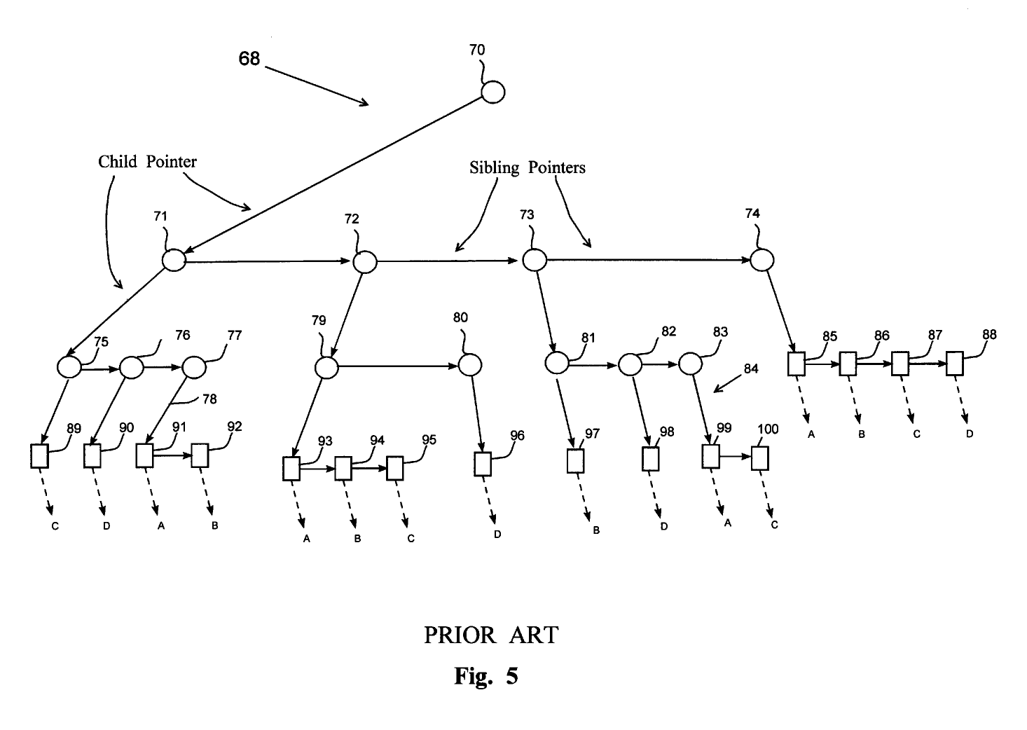

To demonstrate the present disclosure, as well as to refer to the earlier disclosures about content menu 5, a relational database manages a collection of books. FIGS. 4a through 4c displays target database 35 that consists of three tables: Book_Desc 40, Authors 50, and Book_Pub 60. Each row or entry in Book_Desc table 40, depicted in FIG. 4a, represents a single book, such as 47. In relational database terms, each row in table 40 accounts for a book. So data in Book Title attribute 44 refers to its title, its identification number can be found in BID attribute 42, and the language of the book in Book_{—} Language attribute 45. Other, related information on each book—following the relational model—is contained in different tables to avoid update and delete anomalies. This related information includes the Authors table 50 and Book_Pub table 60 that have a one-to-many relation to each book in table 40.

At this point in the discussion, it is important to highlight the fact that the relational table is a two-dimensional logical structure consisting of columns, fields, or attributes and rows, records, or tuples. In strict relational database terms, these dimensions are “attributes” and “tuples.” However, other terms, such as “fields” and “columns” are used interchangeably with attributes to describe the vertical dimension of this logical structure. And the terms “rows” and “records” are also used interchangeably with “tuples” to describe its horizontal dimension.

Some attributes in the relational table manage data that describes the table's contents, such as Book Title 44 in table 40 or Author Name 52 in table 50. Another type of attribute contains value-based links between two tables, such as AID attribute 51 in table 50, a primary key 48a and AID attribute 43 in table 40, its operational counterpart, foreign key 48b. This pair of keys, primary key 48a and foreign key 48b, give the relational model its distinctive value-based navigation capabilities. Operationally, this has been described by Atzeni et al., as the links “between one table and another at the row level”, (p. 21-22). In this new database interface, the functional distinction between attributes that manage data that describe information in a table versus attributes whose data links one table to another is critical to the understanding of the rules that govern the formation of the BAR chain. Table fields that are declared as primary and foreign keys in the schema, or used that way, are identified here as operational attributes 48. Primary key 48a represents a particular type of key, one whose data values make each row in the database table unique. From this perspective, foreign key 48b establishes the linkage between rows in one table to a specific row in another table. Therefore, the relationship between primary key 48a and foreign key 48b is complementary; it is also bi-directional. Together, foreign key 48b and primary key 48a link two tables together at the data level in each row. All other table fields, by default, are considered by the inventor to be conceptual attributes 49. These attributes manage data that describe the type of information that can be found in a table.

This distinction between operational attributes 48 and conceptual attributes 49 will be made throughout this disclosure, to signal its singular importance over the prior database research which did not make this distinction. In his seminal 1970 ACM paper that introduced the relational model, Codd addressed this distinction, but only in a very general way; it had no consequence on our understanding of data relations or data networks whatsoever. The present disclosure, along with an earlier one made by Zellweger on the BAR and the BAR query (Ser. No. 13/033,298 Feb. 25, 2011), can show, in a very concrete way, how these two different types of attributes contribute to the rules on pairing attributes to expose binary attribute data relations and data networks.

FIG. 5 is a graphic representation of such a data network. It is the open hierarchical data structure (OHDS), a. k. a. k2h, consisting of nodes and edges. As mentioned earlier, this hierarchical structure provides the framework for generating compiled menu data files 28. The structure of OHDS 68 is somewhat similar to the LEFT child—RIGHT sibling structure described by Knuth (p. 348). However, the paths in the OHDS can overlap, and it has its own interactive, graphical user interface to manage them. Therefore, these two features indicate that the OHDS goes well beyond the simplicity of the data structure described by Knuth, which is used only narrowly as a memory management tool.

Each node in OHDS 68 is added either by program logic or by hand. Flow in 68 starts at root node 70 and descends through one or more branch nodes, like 71 or 72, to leaf nodes at the bottom of the structure, such as 89 or 92. Below the root node, all branching nodes have a child pointer. This child pointer gives OHDS 68 its distinctive top-down, hierarchical flow. In content menu 5, the child pointer connects a list item at one level with its successor list at another level of the structure. The branching node can also have a sibling pointer like the one identified on node 93. This pointer is used to create the list of data topics displayed in list menu 6 of content menu 5. At the end of each menu path in OHDS 68, the label on each leaf node refers to a primary key 48a, like leaf nodes 89 or 93. This value links content menu 5 to a window that displays information managed by the database.

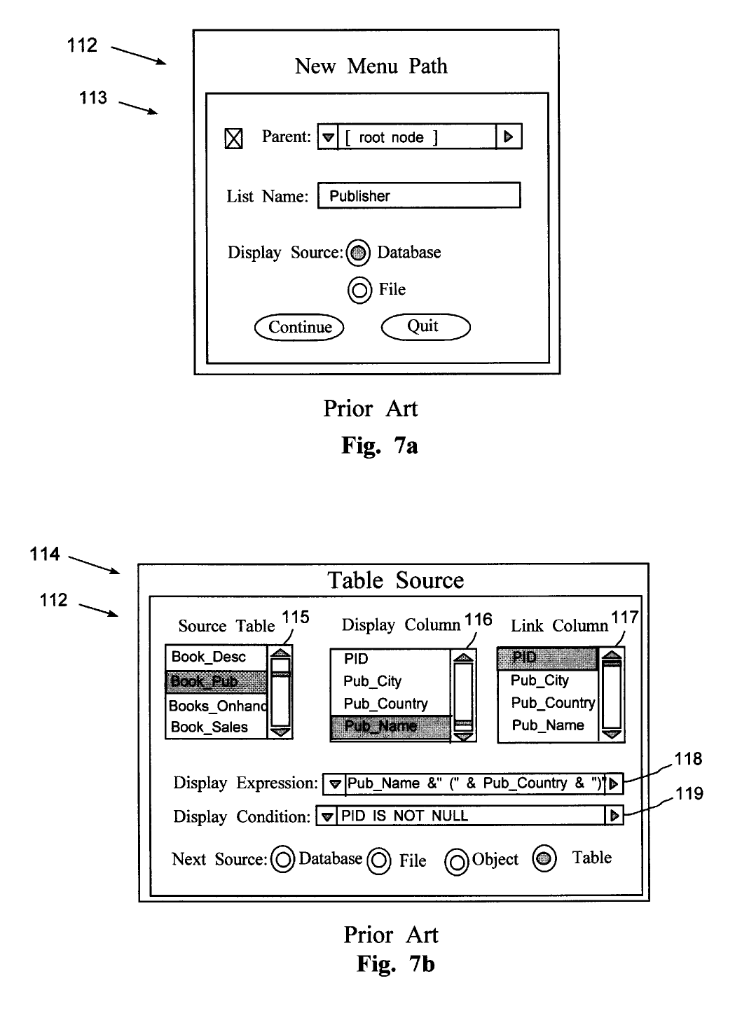

FIG. 6 shows how data in table 104 represents each node in OHDS 68. As indicated earlier, development system 27 deploys OHDS 68 in table 104 to compile menu data files 28 for content menu 5. Attributes in table 104 include each node's label in TOPIC field 106 or its numeric identification in NODE field 105. Alternative embodiments of structure 68 include predetermined file formats as well as other types of database architectures and file structures. Once OHDS 68 is fully built, development system 27 uses program logic to navigate its hierarchical data in PARENT 107, CHILD 108, and LEVEL 109 fields to segment OHDS 68 into mutually exclusive network segments. Next, the program logic directs each network segment to a compiled file 28 for content menu 5. An alternative embodiment of compiled file 28 is generated at runtime using meta-query data to display “live” data in content menu 5.

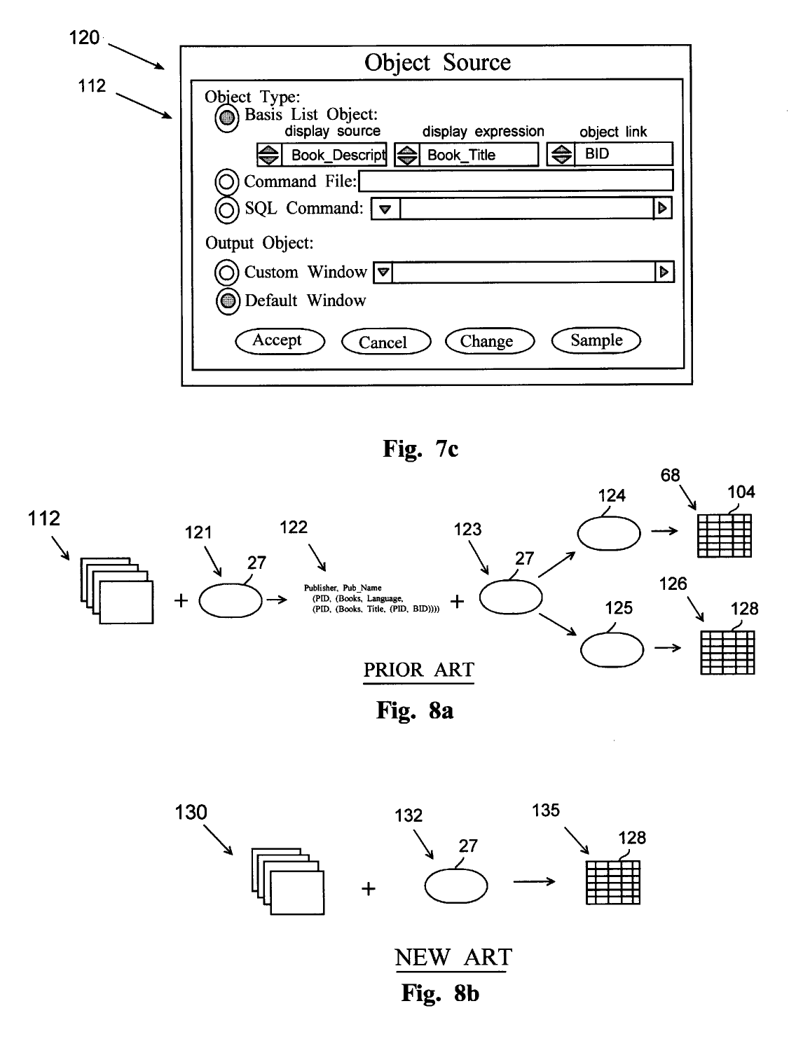

FIGS. 7a through 7c depict the former developers' interface 112 in development system 27. A developer employs interface 112 to navigate over a target database schema, like the Books database 35 to select meta-query data. Development system 27 transforms the sequence of attribute or field selections into a nested symbolic expression. This expression stores critical information on how to extract data and its relations from database 35 and on how to transform them into nested data-topic lists in OHDS 68.

In old interface 112, the menu developer would start with New Menu Path 113 in FIG. 7a. After supplying a network name and selecting a parent node to OHDS 68 in table 104, the developer selects an external source of menu data by clicking on either the Database or File radio button. Menus in interface 112 display table attributes of an external database or, in the case of a file, its field-based record content. This information enables the developer to select relevant attributes, or fields from a data file, that can serve as sources for menu data file 28. After selecting the Continue button in interface 113, the next interactive menu in the navigation sequence appears.

When the Database button is selected, interface 113 steps the developer through a series of menus to connect to the external database 35. The next form in this sequence displays Table Source 114 in FIG. 7b. Menu 114 enables the developer to select a table in database 35 from a scrolling list 115 of table names. After choosing a table name, Display Column 116 and Link Column 117 scrolling lists display the table's attributes, allowing the developer to identify sources for the display and link functions. Attributes in Display 116 furnish data topics for a list menu 6. Attributes in Link 117 provide link values that will connect a data in one list menu 6 with its successor menu 6. The developer can also supply an output format for the data topics at field 118. In text field 119 he or she can also provide selection conditions to the underlying retrieval operation to filter out any impurities.

To build a network of data relations from raw data in the database, the developer navigates from one Table Source menu 114 to another 114 by selecting the Table button in the Next Source options. At this point, when the developer selects a table, Display Column 116 and Link Column 117 display all of its attributes. This process repeats until the Object button in 114 is selected. Program control in 112 fetches the pair of selections in one interface 114 to create an embedded clause in the prior symbolic expression.

When the developer selects Object button as the next source, development system 27 displays the Object Source options 120 shown in FIG. 7c. Menu 120 is the last interface in a navigation sequence. The developer in 120 selects an attribute that can serve as a primary key 48a. Next, program control associated with the prior interface generates symbolic expression 122, which, after system verification and the end user's confirmation, is constructed based on all of the selections made by the developer in interface 112.

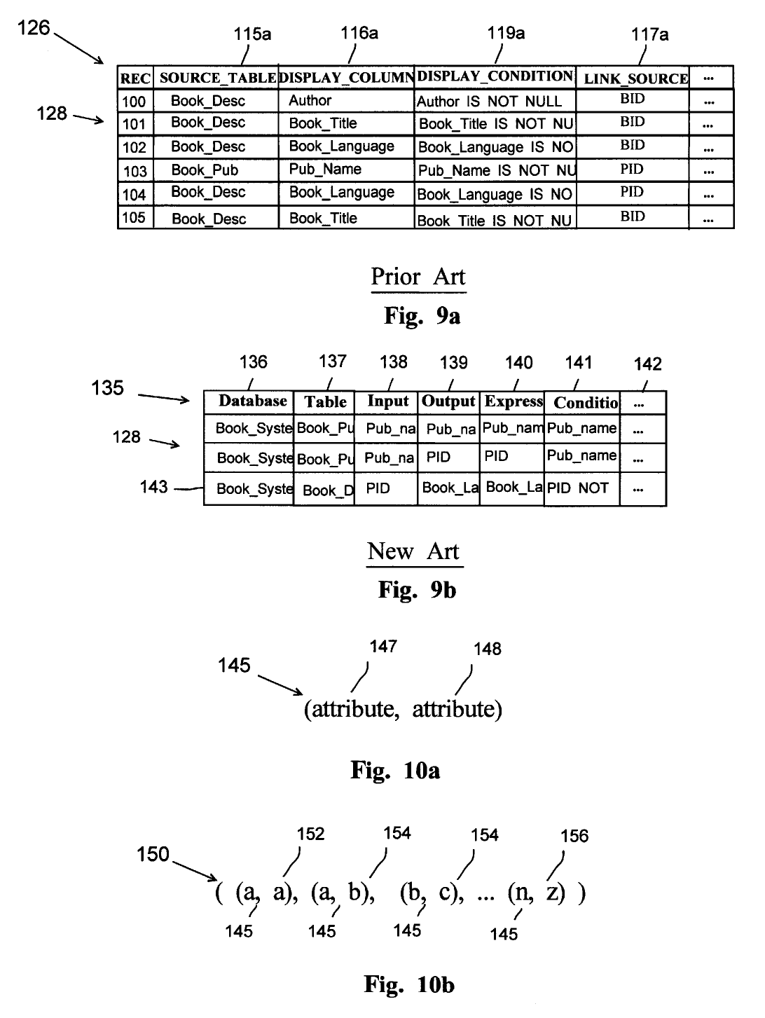

FIGS. 8a and 8b illustrate the relationship between the developers' interface and the meta-query data in the new and old techniques. In the prior approach, program flow 112 of meta-query data is graphically shown in FIG. 8a. First, front-end algorithms 121 in development system 27 generate symbolic expression 122 according to the prior definition. This expression corresponds to the attribute selections made by the developer in interface 112. The back-end algorithm 123 in development system 27 then parses expression 122. Next, program control 124 in back-end process 123 generates OHDS 68 in table structure 104 (U.S. Pat. No. 6,279,005), which is a framework for compiled menu data files 28. Other program control 125 in the back-end parse symbolic expression to extract meta-query data for storage in structure 128 to generate runtime menu data files 28.

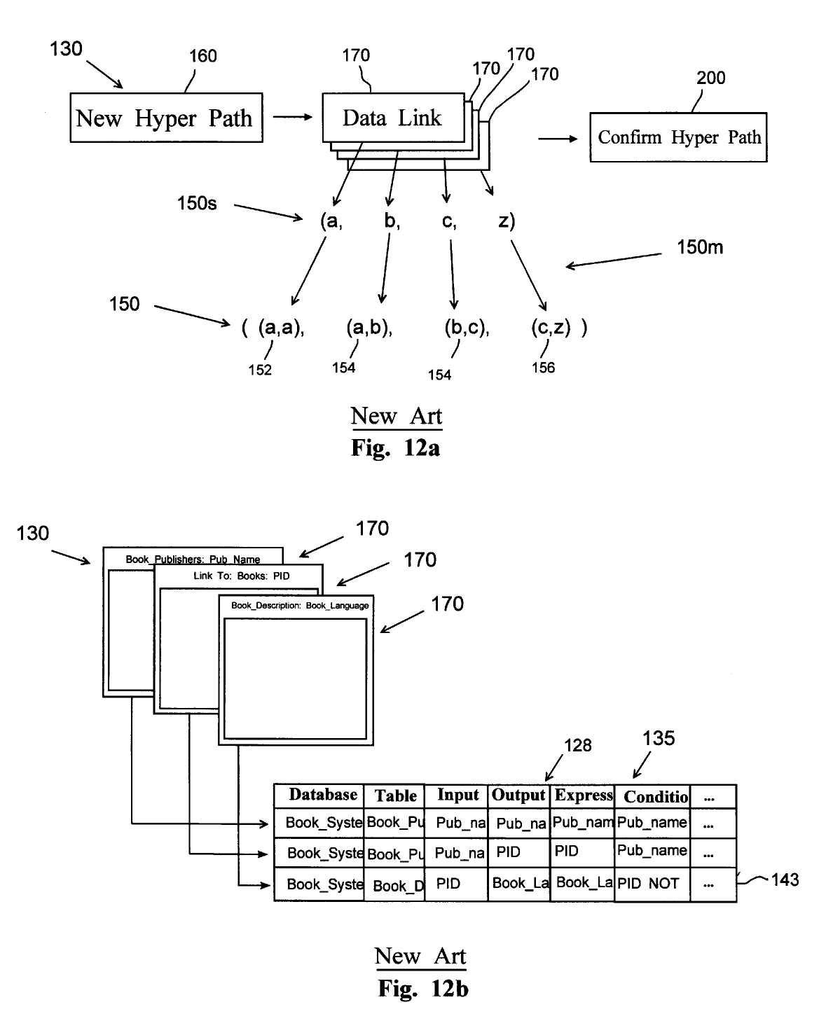

FIG. 8b shows the new flow of program control 132 in development system 27. First, program logic 132 captures selections made by the menu developer in the new interface 130 and stores them directly into structure 128 as meta-query data. This new streamlined approach enables the same meta-query data to be used both for creating list menu 6 in content menu 5 at runtime as well as for generating OHDS 68 in table 104 for generating compiled menu data files 28. Furthermore, interface 130 stores this meta-query data according to the new BAR chain in FIGS. 12a and 12b which is an expansion of the BAR format 135 disclosed by U.S. Pat. No. 13,033,298.

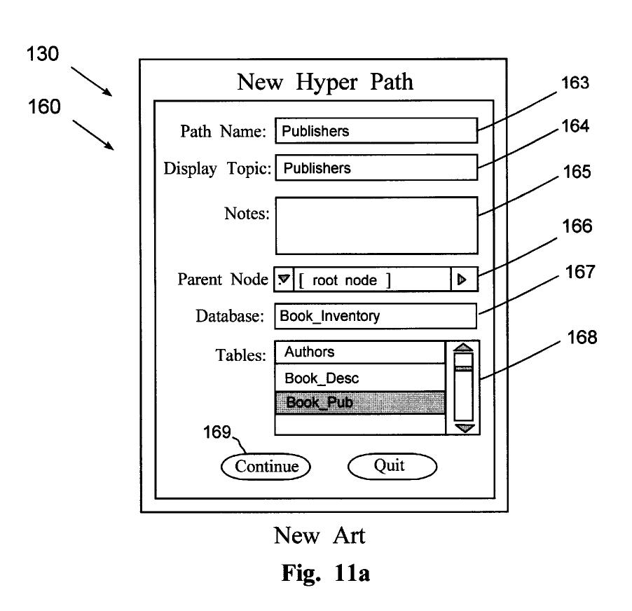

In the next two figures, the new and old format of meta-query structure 128 is graphically displayed. FIG. 9a depicts the prior arrangement 126 of structure 128. This old form has a one-to-one correspondence to the Table Source in 114 of the previous interface 112, with Display Column 116 and Link Column 117 in 114 as attribute 116a and 117a in storage structure 128. In contrast, the new format 135 of structure 128, depicted in FIG. 9b stores meta-query data according to the newly discovered BAR model that represents data relation 12 by a pair of input and output attributes.

When a record-oriented data file yields menu data for content menu 5, the same new format 135 is used. In this case, however, new interface 130 guides the developer in highlighting fields in the file's records using a cursor. Program logic 132 associated with interface 130 transforms their locations into encoded expressions for storage. In turn, alternative algorithms in development system 27 fetch data from these highlighted locations to extract data lists for the content menu.

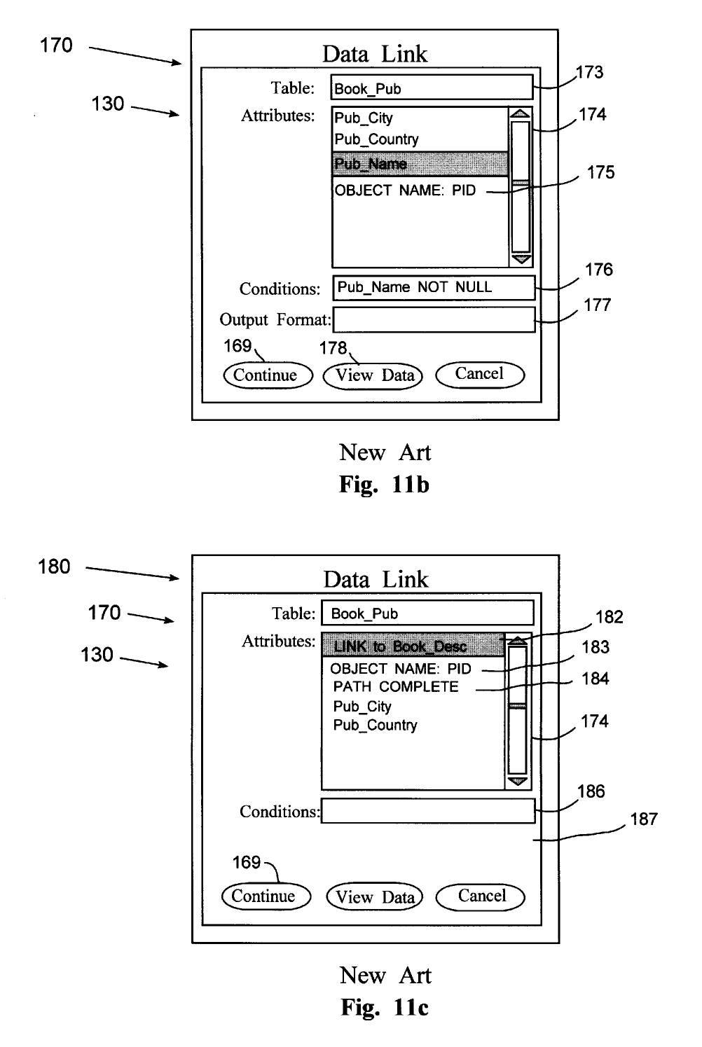

The next two figures, FIGS. 10a and 10b, show binary attribute relation or BAR 145 and its expansion into the BAR chain 150, the new material presented by this disclosure. Zellweger recently disclosed the BAR model of data relations as a logical relationship between two database attributes. An example of this is data relation 12 in FIG. 1. It is important to note that relation 12 is an essential feature of content menu 5, and it is used throughout its construction.

The BAR query, a primitive retrieval operation—having a single input and output channel—is responsible for exposing data relation 12. Together, the BAR model and the BAR query can and should be viewed as practical tools that led to the discovery of a progression of BAR models whose properties and rules are identified here as the BAR chain. In fact, all three of these concepts, the BAR model, the BAR query and the BAR chain are related to each other, and all three have contributed to the incremental discovery of each other.

The BAR 145 represents a pair of attributes drawn from the same database table. In notation, BAR 145 is graphically depicted in FIG. 10a. Each element in BAR 145 directly relates to the input and output attributes of a BAR query. The left position 147 in BAR notation 145 depicts input; the right position 148 depicts output. When these two elements merge with keywords in the BAR query, and the command executes, a binary attribute data relation, such as data relation 12 disclosed by Ser. No. 13/033,298 is exposed. Thus, BAR 145 both models data relation 12 as well as serves as meta-query data used in the construction of a query that extracts it from a data source.

In the next figure, the notation in FIG. 10b depicts BAR chain 150, the new technique that models a data network. In this expansion, each pair of attributes in 145 now corresponds to a link in BAR chain 150. From this perspective, BAR chain 150 provides the framework for exposing the patterns and rules on the pairing of attributes in each link 145. For instance, each BAR link 145 reveals how an output attribute in one BAR link 145 serves as an input attribute in the next BAR link 145 of the chain. In this regard, once again, all three of concepts—BAR 145, BAR chain 150, and the BAR query—all work together to expose each others' distinctive identity.

The rules that govern the formation of BAR chain 150 are based primarily on the fact that the relational model employs two different types of attributes. As mentioned earlier in this disclosure, these attributes are either conceptual 49—where its data describes something about the information modeled by the table—or they are operational 48, where its data serves as value-based links between two tables in the database system. This functional distinction between describing and linking attributes and their data, however, can be ambiguous as the reader will see shortly. To further complicate matters, the BAR query treats all input data operationally as value-based links, based on how the database employs pattern matching on 0's and 1's to test a target condition with data associated with each record. This confusion—where functionality and usage overrides schema declarations—can and will be cleared up, but this can only be done when viewing attributes from the perspective of the BAR chain 150.

The specification now discloses that BAR chain 150 has three different types of links: 1) a source link 152, 2) a destination link 156, and 3) one or more branching links 154 in between the source and destinations links. Each branching link serves up two different types of data that correspond to the two different types of attributes previously identified. One type of data is descriptive, and it serves as topic items for the list menu 6 in content menu 5. The other type of data represents value-based data links that are used by the database system to connect rows in one database table to rows in another table. Together, these two types of data enable BAR chain 150 to model a network of data relations.

The first link in BAR chain 150 starts with source link 152. It always treats its attributes—regardless of their schematic declaration—in a strictly pragmatic fashion as pools of data that describe information modeled by the database. For practical reasons, namely possible impurities in the database, source link 152 is reflexive, so specially designed selection conditions can filter out impurities. From the end-users' perspective, the data in a source link is always conceptual, so it could even be a primary key 48a, say in the case where a serial number or numeric product code would be meaningful to the end-user. Therefore, source link 152 always refers to an attribute whose data can provide “descriptive” data-topics, regardless of the schematic declaration.

And lastly, the final link 145 in BAR chain 150 is identified as destination link 156. It too has a distinctive pattern. Link 156 always employs primary key 48a in output position 148 of BAR 145. This output element always functions in the traditional role of primary key 48a that relates to a unique record in a database table. In BAR chain 150, this data value serves as a link between content menu 5 and the window that displays information managed by the database.

In BAR chain 150, the pair of elements in each branching link 154 has an alternating pattern when all of these attributes come from the same table. In this case, output in one BAR 145 is employed as input in the next BAR 145 link, to form this alternating pattern between two adjacent links 154. In other situations, when operational attributes in their traditional role link two tables, a pair of primary and foreign keys alternate between adjacent links in BAR chain 150. One key in the pair is in output position 147 of link 145, and its counterpart is in input location 147 of the next link in BAR chain 150. Therefore, this pairing of primary and foreign keys across tables always occurs between two adjacent links 145 when connecting rows in one table with the rows in another.

BAR chain 150, together with the BAR query, lays all of the ambiguity of attribute roles and functions in the relational model out in plain view. The difference between attribute declarations in the schema and their actual usage in the content menu could now be inspected and analyzed in a systematic fashion. This working view affords the opportunity to discover the real syntactical rules that govern the formation of BAR chain 150 and the pairing of attributes in its interrelated links.

Having identified these rules, the inventor has applied them to the functionality of the new developers' interface 130. Most notably, this includes embedding the rules of BAR chain 150 directly into the types of options that are displayed to the end-user, as he or she navigates over target database schema. These rules make new developers' interface 130 context-sensitive according to the formation of BAR chain 150. To demonstrate this, FIGS. 11a through 11e portray a navigation sequence that could be taken by a developer to capture meta-query data from target database 35. Each menu interface in this scenario guides the developer by only displaying menu selection options that would be consistent with the rules that govern the formation of BAR chain 150. A summary of these rules and how they impact the type of choices shown to the developer will be presented shortly in Table 1.

The first menu in the new developers' interface 130, New Hyper Path 160, is displayed in FIG. 11a. The developer employs interface 160 to give the new data network model a name in field 163. Next, the developer adds a new display topic for this network, such as “Publishers” in area 164, that will appear in content menu 5 as a selectable list item. Text field 165 records any comments or notes about this new network model. At 166, the developer navigates an existing OHDS 68 in structure 104, using a built-in content menu 5 to identify a parent node in for this new data network.

Next, a target database name is selected from a drop-down list 167 of database names. The development system manages the integration of communication software and contact information to establish a seamless software connection to database 35. Scrolling region 168 displays a list of the database's tables. To start navigating over the database 35 table schema, the developer selects a table name in 168 followed by the Continue button 169 in interface 130.

Data Link menu 170 depicted in FIG. 11b appears next. It is important to note that there is a one-to-one correspondence between each Data Link 170 in the developers' navigation of target database 35 and each BAR link 145 in a Bar chain 150. FIG. 12a graphically illustrates this relationship.

In each Data Link interface 170, Table field 173 displays the name of the previously selected table name. Directly below, scrolling region 174 shows the current table's attributes as selectable list items. The first time Data Link interface 170 is displayed in 130, all of the table's conceptual attributes 49 appear. And, none of its operational attributes 48 are presented. The only exception to this rule is when primary key 48a describes or identifies information managed by the database for the end-user. In this circumstance, the developer indicates its special status in development system 27 and primary key 48a would be displayed as an “OBJECT NAME” at entry 183. Interface 130 controls the attribute display in this manner to conform with the syntax of BAR chain 150. By clearly labeling all of the relevant options, the first Data Link 160 directly corresponds to the rules for the formation of source link 152 in BAR chain 150.

After selecting an attribute in 174 and Continue button 169, a new Data Link 170, displayed in FIG. 11e redisplays any remaining unselected table attributes in Book_Pub in region 174 of interface 180. Interface 180 now new introduces other new ways primary key 48a could be used in the construction of menu data for content menu 5 as it now treats primary key 48a in three different ways:
As an attribute which describes an entity, in the OBJECT NAME: PID″ entry 183.
As an attribute paired with a foreign key, in the “LINK to Book_Desc” item 182, which enables the developer to navigate to a new table, whereby the next Data Link 170 would display the attributes of “Book_Desc” table 40.
And finally, as an output attribute in a destination link 156 that terminates any further navigation when the “Path Complete” entry 184 is selected. When this occurs, the primary key is assigned to output position 147 of destination link 156 in chain 150.

In remaining figures in this series, FIGS. 11c through 11e show how the rules that govern the formation of links in the BAR chain 150 control the menu flow in this interface. This series of figures also demonstrates how these rules make each Data Link 170 context sensitive. The display is based on the type of attribute: conceptual versus operational, and on the link type in BAR chain 150. As indicated earlier in FIG. 10b, the BAR chain 150 starts with source link 152, terminates with a destination link 156, and includes one or more branch links 154. Table 1 below presents a brief summary of these rules.

TABLE 1

| Attribute Types Displayed: | Data Link as Source | Data Link as Branch |
|---|---|---|
| Conceptual | All conceptual attributes. | Any unselected conceptual attributes. |
| Operational: Primary Key | ‘Object Name’ clause only. | 1. ‘Object Name’ clause. |
| | | 2. ‘Link to’ clause. |
| | | 3. Path Complete’ clause. |
| Operational: Foreign Key | Never | Never, but implied usage by the ‘Link |
| | | to’ clause. |
| Next Interface: | Data Link as Branch | Data Link as Branch or Confirmation. |

Across the top of Table 1 are columns that indicate whether Data Link 170 is either Source link 152 or Branch link 154 in BAR chain 150. These two types of links dictate how region 174 displays conceptual and operational attributes. The source and branching links indicate which menu comes next in the sequence, either another Data Link 170 or a Confirmation menu when ‘Path Complete’ is selected. The “Next Interface” is presented in the bottom row of Table 1.

The first Data Link 170 of the new developer's interface 130 represents source link 152. In list 174, it displays all conceptual attributes as well as a primary key 48a when it describes or names information in the table. From this point on, all other Data Link interface 170 represent branch links 154. In this new capacity, Data Link 170 only displays any unselected conceptual attributes and the primary key when it relays information to the end-user.

Before moving on to the next figures in this scenario, other menu details about Data Link 170 will now be taken up in FIG. 11b. Directly below list region 174 in 170, there are two input text fields. In field 176, a conditional clause can be added to the underlying BAR query to improve its precision when this retrieval operation extracts data from external database 35. Also, output format details can be supplied in field 177 to format output from this query to improve its readability or overall appearance. Directly below this area there are two buttons. By selecting View Data button 178, the developer can view a pop-up list of data values of the selected attribute in region 174. The Cancel button closes the current Data Link 170 and makes the prior menu active. And lastly, by selecting the Continue button 169, the developer proceeds to the next Data Link 170.

The next figure in this directed sequence is interface 180 depicted in FIG. 11e. This interface draws on the same Book_Pub table 60, but it refreshes region 174 only to show options that correspond to branch link 154 in chain 150. In keeping with this rule-based implementation, region 174 in interface 180 now only displays any unselected conceptual attributes 49 from the current table.

Other context-sensitive differences between Data Link 172 and Data Link 180 can be observed in the area directly below list region 174. When the “LINK to” item is selected, for instance, Data Link 170 filters out the Output Format label and field 177 in region 160, as entry 182 represents operational data that only works internally at the system level. However, the Conditions label and field 186 remain, so that the developer can supply additional selection conditions by hand if he or she chooses to.

After selecting “LINK to Book_Desc” entry 182 and Continue button 169 in 180, the next Data Link interface 170, identified in FIG. 11d as 190, is displayed. Data Link 190 presents “Book_Desc” 40 attributes in list region 174 according to the rules outlined in Table 1. When the developer selects a “LINK to . . . ” entry, this request is encoded internally as a pair of adjacent branching links 154 in chain 150 that connect the developer to a new table and its display. Program control in 27 manages the pairing of foreign and primary keys between these source and destination tables in a database system, thereby enabling the developer to navigate freely from the current to another over the database schema, as the database architect intended.

When PATH COMPLETE item 198 in list region 174 and Continue button in region 190 are selected, interface 130 displays the Confirm Hyper Path menu 200 shown in FIG. 11e. In confirmation interface 200, field 177 presents the target database name, and scrolling list 202 shows the data topic attributes and link attributes that were selected by the developer. The sequence is chronological. Each data-topic source is displayed in a “table: attribute” format. Furthermore, each link is introduced by a “LINK to” prefix along with the destination table and the key that binds the two tables together. While the developer never selected the OBJECT NAME in this example, if it was then it too would be included in this list.

Lastly, the Confirm Hyper Path interface 200 also displays summary information about the new data network in region 205. These metrics include the number of new list menus, new paths, and the depth of the new network modeled by the developer's navigation. At this point, the developer can select Accept button 107 to capture the underlying meta-query data and store it in database structure 128 of development system 27. Otherwise, Quit button 208 would be used to close interface 130 altogether and discard its meta-query data. By selecting Cancel 209, development system 27 returns the developer to the previous Data Link 170 on the screen.

The description above concludes the disclosure of the preferred embodiment of new developer's interface 130. Alternative embodiments of 130 include other types of Data Link 170. For instance, interface 170 could present a data file that just displayed record-oriented data. This interface would enable the developer to select Display and Link fields by moving a cursor to highlight his or her selections. In this case, the program logic will link these choices to other record-oriented selections or to database table attributes. Alternative graphic user interface embodiments of Data Link 170 include tree views and area maps to represent database schema 35 as a navigation surface. These alternatives also include any graphical user interface that would enable developers to select a sequence of tables and attributes and to capture this progression in a symbolic expression, like BAR chain 150, which contains meta-query data.

The next two figures in this specification, FIGS. 12a and 12b, show the relationship between the menus in new developers' interface 130 and BAR chain 150. These figures also show the relationship between the sequence of menus in interface 130 and structure 128 that stores and manages meta-query data.

FIG. 12a highlights the relationship between the sequence of Data Link menus 170 in interface 130 and BAR chain 150. Interface 130 starts with New Hyper Path menu 160 and concludes with Confirm Hyper Path menu 200. In between these two menus, there are one or more Data Link menus 170. As mentioned earlier, each 170 corresponds to a link in BAR chain 150. The short form of BAR chain 150 is displayed at 150s. Each element in BAR chain 150s corresponds to an attribute entry selected in region 174 of menu 170. Algorithm 150m in the mapping algorithm 132 of development system 27 transforms each element in short form 150s to a pair of attributes in BAR link 145 of the long form BAR chain 150, based on the patterns and rules presented earlier in the discussion of FIG. 10b.

The next figure in this series, FIG. 12b highlights the correspondence between each Data Link 170 and meta-query data stored in structure 128 according to its new format 135. Program control 150m in mapping algorithm 132 of the development system 27 can either establish an embodiment of BAR chain 150 in structure 128, or 150m can reconstruct each link in chain 150 from short form meta-query data (150s) in structure 128, depending upon the optimization and configuration of system 27.

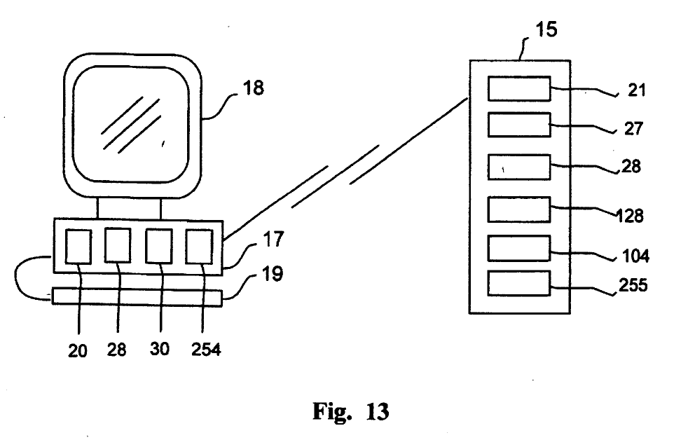

FIG. 13 presents the architecture of the client-server apparatus of the new technique. In one embodiment, client computer 17 has software cookie 254 that manages data on the client machine for each end-user session. Browser software 30 communicates with server 15 to request menu data to build and manage nested list menus 6 of content menu 5 on client 17. Server 15 generates menu data 28 based on meta-query data in structure 128. Server 15 also manages client session information with software routines 255. In an alternative embodiment, the software architecture favors a server-based approach that uses menu data files 28 on server machine 15 to build thin presentation software for the client browser software.

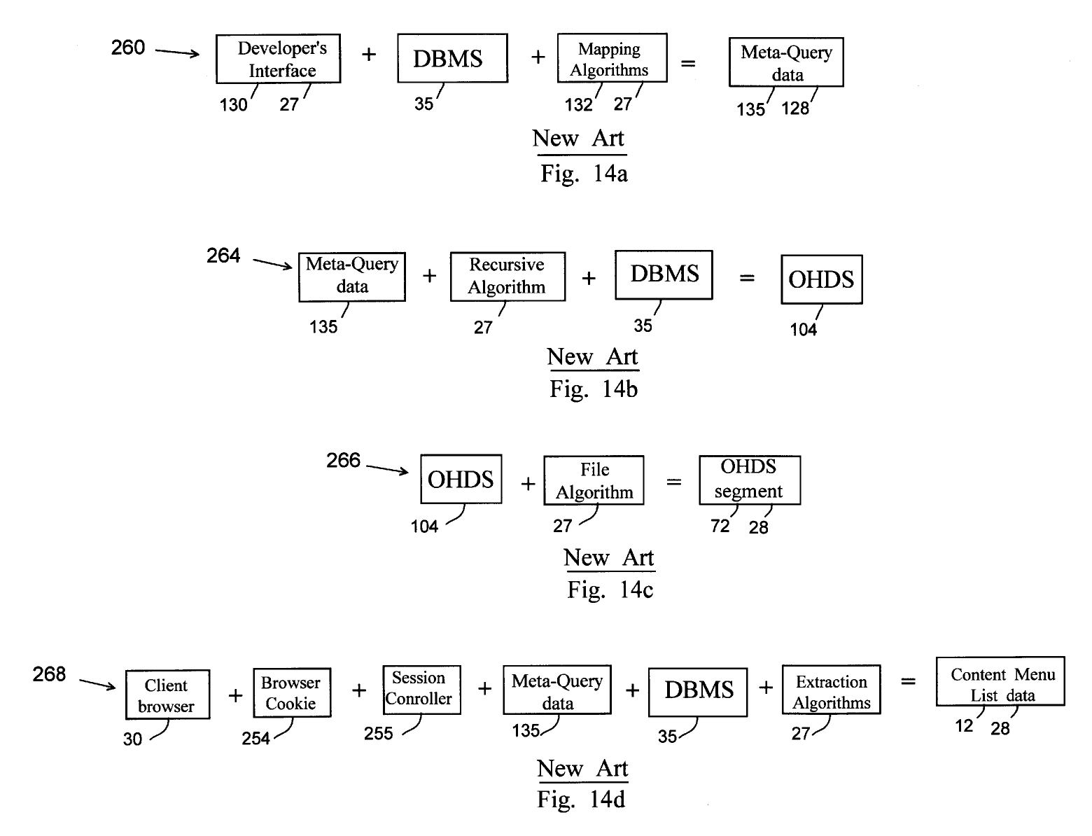

In the final series of figures in the specification, FIGS. 14a through 14d display the new program flow of software components used to construct compiled and runtime list menus 6 of content menu 5. The new format 135 of BAR chain 150 in structure 128 is responsible for this improvement.

In the final figure of this drawing series, FIG. 14a shows how the new software components in this specification capture meta-query data from remote database 35 and store it directly in structure 128 according to BAR chain 150. These new components include developers' interface 130 and mapping algorithms 132 in development system 27 that were introduced earlier in this disclosure. Together, interface 130 and program control 132 enable a developer to navigate over target database 35 to capture models of data networks for the content menu. The new BAR chain 150 dictates how these attributes get stored as meta-query data in structure 128. In an alternative embodiment of these techniques, the new interface 130 includes Data Link 170 that enables a developer to view the contents of a data file as field oriented structure. Alternative program logic 132 encodes these fields symbolically as fixed or relative locations in the file; they too get stored in the new format 135.

The next figure in this series, FIG. 14b shows the new flow of software components that generate compiled data files 28. This process starts with the construction of OHDS structure 68 in database 104 of development system 27, using meta-query data in structure 128 and a recursive algorithm in development system 27. This algorithm retrieves data-topic lists from target database 35 and applies them to OHDS 68 systematically, by adding data output to leaf nodes at the bottom of structure 68. Biggs describes this tree construction as being similar to the flow of the depth first search. The recursion presented here is programmed by the meta-query data in the BAR chain 150, including alternative embodiments that encode data file field locations as branching links as well as alternative recursion subroutines that process them. Upon completing this process, mapping algorithms in development system 27 traverse OHDS 68 in table 104, to segment it into mutually exclusive networks. Next in FIG. 14c these algorithms assign each network to one or more compiled menu data files 28. Therefore, each file in this collection of compiled files contains a network segment of OHDS 68, like node 72 and its children in FIG. 5.

The last figure in this series, FIG. 14d, shows the program flow for constructing runtime data files 28. This program flow starts with a request for menu data made by an agent, either by browser software 30 on a client 17 or by the server itself. The controller 255 on the server 17 or the client cookie 254 or both manages the session information. This information includes the current active list menu 6 of content menu 5 and the end user's selection of one of its list items. Session controller 255 receives the request and dispatches it to retrieval routines managed by development system 27. The program logic in development system 27 fetch meta-query data from structure 128 to generate the next list menu 6 of content menu 5. This meta-query data enables these routines to extract a particular data network from target database 35 formatted for menu data file 28. Next, the controller 255 sends the newly generated runtime menu data file 28 back to either software 30 on client 17 or to other program logic on server 15 that merges this data with presentation instructions.

### CONCLUSION

This concludes the description of an embodiment of the invention. While the preferred embodiment of this invention was a relational database, alternative embodiments include data from other data models, from other data structures, and even from system files. Therefore, the preceding description of the embodiment of this new technique has been presented for the purpose of illustration and description. It is not intended to be exhaustive or limit the invention to the precise form disclosed. Many modifications and variations are possible in light of the above description. These alterations include the fact that the subject matter here, the BAR chain, represents a radical simplification of complex details. More to the point, such modifications could include more redundancy, either in the BAR chain itself or in the mapping algorithm responsible for retrieving from an external data source. Therefore, the scope of the present invention is not intended to be limited by this description, but rather by the claims appended hereto.

Having described an embodiment of the invention I claim:

1. A computer-implemented method executed by a CPU that guides a developer in selecting attributes from a table in a database system to model a data network embedded in said table comprising the following steps:
displaying a developer interface on a monitor of a computer,
displaying said table interface in said developer interface that presents a filtered list of attributes from a table in said database system,
retrieving a selection made by said developer from said filtered list of attributes,
displaying a navigation option in said table interface that changes said filtered list of attributes from said table to a second filtered list derived from a different table in said database system,
storing a sequence of attribute selections made by said developer in computer memory of a storage device accessed by said computer,
retrieving said sequence of attribute selections from said storage device,
transforming said sequence of attribute selections into a symbolic expression that models said data network embedded in said database system,
parsing said symbolic expression to extract at least one term that is used in a query statement for said database system that constructs said data network,
wherein, said computed-implemented method only displays menu options in said developer interface that would be relevant to the construction of said symbolic expression that models said data network.

2. The computer-implemented method of claim 1 wherein said developer interface is implemented in a computer language that is compatible with at least one operating system.

3. The computer-implemented method of claim 1 wherein said database system has a structure that is compatible with at least one data model.

4. The computer-implemented method of claim 1 wherein said query statement is implemented in a computer language that is compatible with at least one data management system.

5. The computer-implemented method of claim 1 wherein said filtered list of attributes is compatible with at least one graphical user interface.

6. The computer-implemented method of claim 1 wherein a sequence of table interfaces in said developer interface is consistent with at least one rule associated with said symbolic expression that models said data network.

7. The computer-implemented method of claim 1 wherein said filtered list of attributes is consistent with at least one rule associated with said symbolic expression that models said data network.

8. The computer-implemented method of claim 1 wherein said filtered list of attributes is filtered by an access method controlled by a data dictionary configured by a database administrator.

9. The computer-implemented method of claim 1 wherein said element used in the construction of said query statement is consistent with at least one rule associated with said symbolic expression that models said data network.

10. A developer interface on a computer system that guides a developer in selecting attributes from a table in a database system that model a data network embedded in said table comprising:
a monitor on said computer system,
a table interface that displays a filtered list of attributes from said table in said database system on said monitor,
a display option in said table interface that replaces said filtered list of attributes from said table in said database to a different table in said database system,
a selection algorithm that fetches a sequence of attribute selections made by said developer in said developer interface, and that stores said sequence of attribute selections in computer memory of a storage device that is accessible by said computer system,
a retrieval algorithm that accesses said sequence of attribute selections from said storage device, and that transforms said sequence of attribute selections into a symbolic expression that models said data network embedded in said database system,
a query-building algorithm that extracts at least one term from said symbolic expression to construct a query statement for said database system that builds said data network,
wherein, said developer interface only displays menu options that would be relevant to the construction of said symbolic expression that models said data network.

11. The developer interface of claim 10 wherein said developer interface system is implemented in a computer language that is compatible with at least one operating system.

12. The developer interface of claim 10 wherein said database system has a structure that is compatible with at least one data model.

13. The developer interface of claim 10 wherein said query statement is implemented in a language that is compatible with at least one data management system.

14. The developer interface of claim 10 wherein said list of attributes is compatible with at least one graphical user interface.

15. The developer interface of claim 10 wherein said filtered list of attributes is consistent with at least one rule associated with said symbolic expression that models said data network.

16. The developer interface of claim 10 wherein said filtered list of attributes is consistent with an access setting configured by a database administrator in a data dictionary.

17. The developer interface of claim 10 wherein a sequence of said table interfaces is consistent with at least one rule associated with said symbolic expression that models said data network.

18. The developer interface of claim 10 wherein said display option in said table interface is compatible with at least one graphical user interface.

19. The developer interface of claim 10 wherein said selection algorithm that fetches said sequence of selections made by said developer stores said sequence in a pattern that is consistent with at least one rule associated with said symbolic expression that models said data network.

20. The developer interface of claim 10 wherein said retrieval algorithm that transforms said sequence of selections into said symbolic expression is consistent with at least one rule associated with said symbolic expression that models said data network.
